(19) United States
(12) Patent Application Publication
(10) Pub. No.: US 2019/0136120 A1
(43) Pub. Date: May 9, 2019

(54) Fracture Mapping Using Piezoelectric Materials

(71) Applicant: Halliburton Energy Services, Inc., Houston, TX (US)

(72) Inventors: Jim Basuki Surjaatmadja, Duncan, OK (US); Stanley V. Stephenson, Duncan, OK (US)

(21) Appl. No.: 16/095,477

(22) PCT Filed: Jun. 23, 2016
(86) PCT No.: PCT/US2016/038942

§ 371 Date: Oct. 22, 2018

(51) Int. Cl. C09K 8/62; E21B 43/26; G01V 1/42; G01V 1/50

(52) U.S. Cl. CPC C09K 8/62; E21B 43/26; G01V 1/42; G01V 2210/65; G01V 2210/1299; G01V 2210/1429; G01V 2210/646; G01V 1/50

(57) ABSTRACT

Systems and methods of the present disclosure may use mechanically excitable elements and electrically ignitable fluid to generate a fracture map usable to determine a characteristic of a fracture in a subterranean formation. The mechanically excitable elements may include piezoelectric material positioned in the fracture to generate electrical pulses in response to the fracture closing onto the mechanically excitable elements. The electrical pulses may ignite the electrically ignitable fluid causing an explosion of the fluid that may be detectable by microseismic sensors of a microseismic system. The microseismic system may determine the location of each explosion and use the locations to generate the fracture map.

### TECHNICAL FIELD

The present disclosure relates generally to wellbore fracturing and, more particularly (but not exclusively), to mapping a fracture in a subterranean surface adjacent to a wellbore using piezoelectric materials.

### BACKGROUND

Hydraulic fracturing (or “fracking”) may be used to stimulate the production of hydrocarbons from subterranean formations penetrated by a wellbore. A fluid may be pumped through the wellbore and injected into a zone of a subterranean formation to be stimulated at a rate and pressure such that fractures are formed and extended into the subterranean formation. Proppant may be positioned in the fractures with the fluid to prevent the fracture from completely closing. The proppant may hold the fracture open to create a path for fluids from a reservoir in the zone of the subterranean formation (e.g., oil, gas, water, etc.) to flow and be recovered from the wellbore. Characteristics of the fracture may be determined to identify the effectiveness of the fracture and treatment parameters for future fracturing operations.

### BRIEF DESCRIPTION OF THE DRAWINGS

FIG. 1 is a cross-sectional schematic diagram depicting an example of a wellbore environment for acquiring data usable to generate a map of a fracture according to one aspect of the present disclosure.

FIG. 2 is a cross-sectional view of the fracture of FIG. 1 according to one aspect of the present disclosure.

FIG. 3 is a cross-sectional view of a slow-injection pumping device of FIG. 1 according to one aspect of the present disclosure.

FIG. 4 is block diagram of a microseismic system for generating a map of the fracture of FIG. 1 according to one aspect of the present disclosure.

FIG. 5 is a flow chart of a process for determining a characteristic of the fracture of FIG. 1 according to one aspect of the present disclosure.

FIG. 6 is a graphical illustration of an example of a progressive fracture map according to one aspect of the present disclosure.

### DETAILED DESCRIPTION

Certain aspects and examples of the present disclosure relate to injecting mechanically excitable elements and electrically ignitable fluid into a fracture of a subterranean formation adjacent to a wellbore and determining a characteristic of the fracture using locations of explosions of the electrically ignitable fluid in the fracture. The electrically ignitable fluid and the mechanically excitable elements may be injected into the wellbore during a fracturing operation to create the fracture. The electrically ignitable fluid may include an explosive fluid configured to explode, or otherwise ignite, in response to an electrical pulse. The mechanically excitable elements may include piezoelectric material or other devices configured to generate the electrical pulse. After the fracturing operation, the fracture may begin to close onto the mechanically excitable elements and the electrically ignitable fluid remaining in the fracture. The mechanically excitable elements may be squeezed by the subterranean formation as the fracture closes. The compression force exerted by the subterranean formation onto the mechanically excitable elements may cause the mechanically excitable elements to generate electrical pulses due to the piezoelectric characteristics of the mechanically excitable elements. The electrical pulses may cause the electrically ignitable fluid to explode in areas proximate to each mechanically excitable element in the fracture. Microseismic sensors positioned near a wellhead or in a nearby wellbore may detect measurements of the explosions of the electrically ignitable fluid. A processing device of a microseismic device communicatively coupled to the microseismic sensors may receive the measurements from the sensors and triangulate the locations of the explosions to generate a fracture map that may be used to determine dimensional characteristics of the fracture.

In some aspects, the mechanically excitable elements may be injected into the fracture in a manner that reduces a risk of an explosion of the electrically ignitable fluid in response to a premature electrical pulse generated by a mechanically excitable element. In one example, the mechanically excitable elements may be introduced slowly into a flow of the electrically ignitable fluid into the fracture. The mechanically excitable elements may be concentrated into a paste or gel that is housed in a chamber of an injection tool and introduced into the electrically ignitable fluid at a rate slower than the flow rate of the electrically ignitable fluid being injected into the fracture. Similarly, the electrically ignitable fluid may be non-self-igniting, thereby preventing a chain reaction of the explosions either prematurely in the injection device or in the fracture. Each explosion may be contained to an area proximate to the mechanically excitable element generating the electrical pulse for a safer process and a more reliable detection of the explosion in the fracture.

The rate of injection of the mechanically excitable elements into the electrically ignitable fluid may prevent the mechanically excitable elements from colliding with each other, proppant, or other additives in the electrically ignitable fluid during injection into the fracture. In some aspects, slowly introducing the mechanically excitable elements into the electrically ignitable fluid may also allow the mechanically excitable elements to be more evenly dispersed throughout the fracture. Evenly dispersing the mechanically excitable element throughout the fracture may allow for explosions of the electrically ignitable fluid in various areas of the fracture to create a more detailed and reliable fracture map. In some aspects, the explosion generated by the electrically ignitable fluid may generate a unique acoustic wave that may be distinguished by the sensors from other acoustic waves that are natural to the wellbore environment, including seismic acoustic waves caused by the closure of the fracture. The ability of the explosions to create a distinguishable sound may also for a more reliable fracture map.

Also, using mechanically excitable elements, according to some aspects, may be more cost-efficient than other stimulation fluid additives, such as acoustic devices, explosive particles, micro-robots, and other proppant-type additives. For example, the mechanically excitable elements may include piezoelectric material found in nature without an expensive manufacturing process. Using naturally occurring elements to generate the electrical pulse necessary to cause the explosion detectable by the sensors creates a more Earth-friendly, or “green,” process.

Detailed descriptions of certain examples are discussed below. These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. The various figures described below depict examples of implementations for the present disclosure, but should not be used to limit the present disclosure.

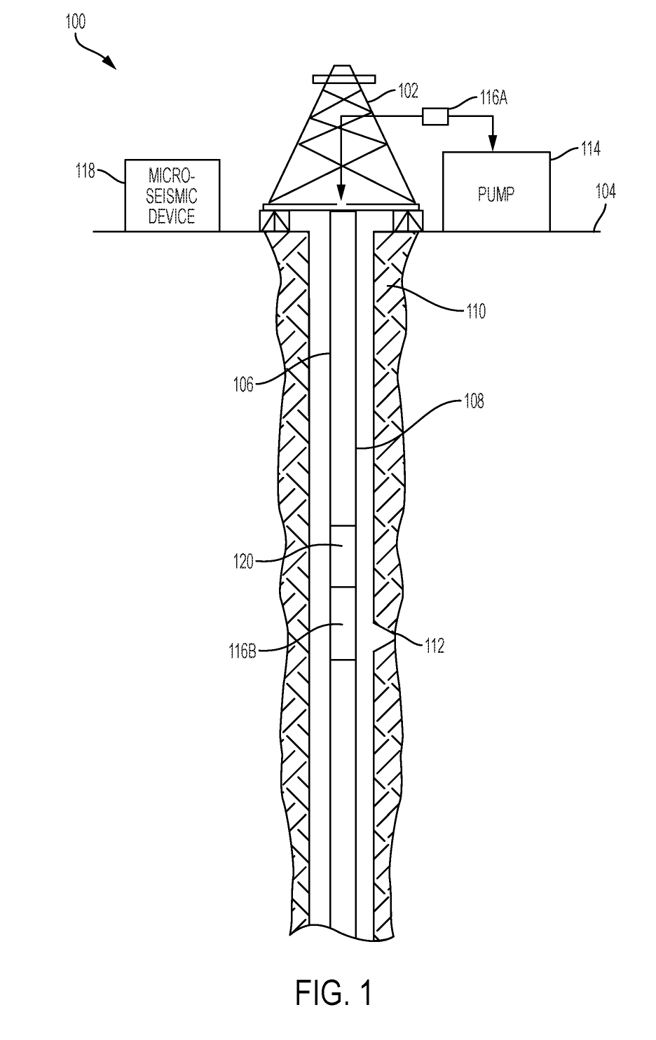

Various aspects of the present disclosure may be implemented in various environments. For example, FIG. 1 is a cross-sectional schematic diagram depicting an example of a wellbore environment 100 for acquiring data usable to generate a fracture map according to one aspect of the present disclosure. The wellbore environment 100 includes a derrick 102 positioned at a surface 104 of the earth. The derrick 102 may support components of the wellbore environment 100, including a tubing string 106. The tubing string 106 may include segmented pipes that extend below the surface 104 and into a wellbore 108. The wellbore 108 may extend through subterranean formations 110 in the earth. The subterranean formations 110 may include a fracture 112. In some aspects, the fracture 112 may be a separation of the subterranean formations 110 forming a fissure or crevice in the subterranean formations 110. In additional aspects, the fracture 112 may be created by a fracturing process in which highly pressurized fluid is pumped into the fluid. A pump 114 is positioned at the surface 104 proximate to the wellbore 108 to pump the fluid into the wellbore at a rate to create the fracture 112. The fracture 112 may serve as a path for the production of hydrocarbons from reservoirs in the subterranean surface fluid. A slow-injection pumping device 116 may be included to inject additional fluid into the fracture 112 to further open or extend the fracture 112 in the subterranean formation 110. In some aspects, the slow-injection pumping device 116 may be positioned at the surface as depicted by block 116A in FIG. 1. In alternative aspects, the slow-injection pumping device 116 may be positioned on the tubing string 106 as depicted by block 116B. Proppant and other additives may be added to the fluid during or prior to the fluid traversing the pump 114. The proppant may remain in the fracture 112 after the fracturing process is completed to keep the fracture 112 from completely closing. In some aspects, the slow-injection pumping device 116 may inject electrically ignitable fluid into the fracture 112 as the fracturing fluid, or in addition to the fracturing fluid. The slow-injection pumping device 116 may also introduce mechanically excitable elements to the electrically ignitable fluid prior to injection of the fluid into the fracture 112. Although the slow-injection pumping device 116 is shown as positioned on a tubing string 106 downhole in the wellbore 108, all, or a portion of, the slow-injection pumping device 116 may be positioned on the surface 104. For example, the slow-injection pumping device 116 may be positioned on the surface 104 downstream of the pump 114. If the slow-injection pumping device 116 is positioned downhole as shown by block 116B, the mechanically excitable elements may be delivered through a coiled tubing while the electrically ignitable fluid is injected through the annulus. Mixing of the two materials may occur in situ in the annulus immediately prior to entering the fracture 112. If the slow-injection pumping device 116 is positioned at the surface 104 as shown by block 116A, mixing may occur at the surface. The slow-injection pumping device 116 may be

A microseismic system, including a microseismic device 118 and an array of sensors 120, is also included in the wellbore environment. The microseismic device 118 is positioned on the surface 104 and may be communicatively coupled to the sensors 120. The sensors 120 are positioned on the tubing string 106 or on tubing in a nearby well. The sensors 120 may include microseismic sensors or transducers configured to measure acoustic waves in the wellbore 108. In some aspects, the sensors 120 may detect, or measure, acoustic waves generated by explosions of the electrically ignitable fluid in the fracture 112. In additional aspects, the sensors 120 may be tuned to distinguish acoustic waves generated by the explosions from other seismic waves traversing the subterranean formation 110 and the wellbore 108. For example, the sensors 120 may be tuned to a specific frequency that may detect the explosions and distinguish them from other acoustic waves operating at different frequencies. The sensors 120 may transmit the measurements of the explosions of the electrically ignitable fluid to the microseismic device 118 at the surface 104. In some aspects, the sensors 120 may be wirelessly coupled to the microseismic device 118. In other aspects, the sensors 120 may be coupled to the microseismic device 118 via a suitable wired connection. Although the array of sensors 120 is described as positioned on the tubing string 106, the sensors 120 may be positioned in various positions downhole in the wellbore 108 without departing from the scope of the present disclosure. For example, the sensors 120 may be positioned along a wall or casing of the wellbore 108. The array of sensors 120 may include any number of sensors, including one. In some aspects, the process used to determine a location of the explosions may dictate the number of sensors required in the array of sensors 120. For example, the microseismic device 118 may be configured to triangulate a position of the explosions of the electrically ignitable fluid in the fracture, requiring the array of sensors 120 to include at least three sensors.

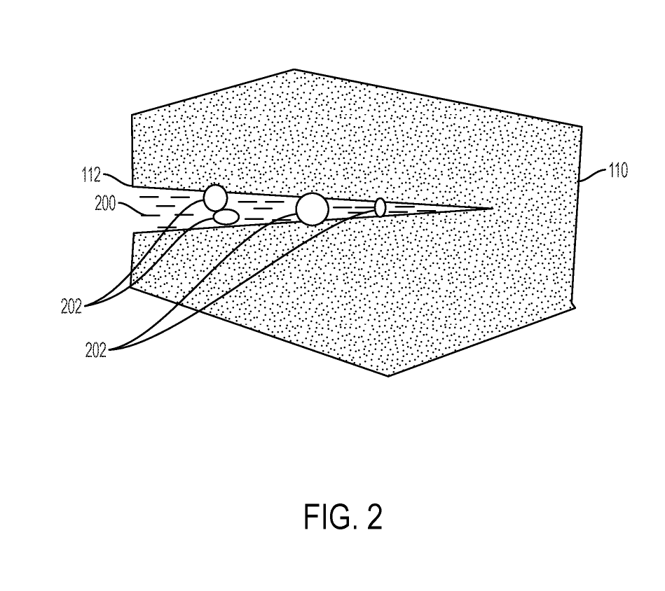

FIG. 2 is a cross-sectional view of the fracture 112 of FIG. 1 according to one aspect of the present disclosure. The fracture 112 includes electrically ignitable fluid 200. In some aspects, the electrically ignitable fluid 200 may be injected into the electrically ignitable fluid by the slow-injection pumping device 116 of FIG. 1. In some aspects, the electrically ignitable fluid 200 may include any fluid that is ignitable in response to the application of an electrical signal to the fluid. In other aspects, the electrically ignitable fluid 200 may include a fluid having electrically ignitable explosives mixed into the fluid. In some aspects, the electrically ignitable fluid 200 may be inert until an electrical signal is applied to the electrically ignitable fluid. In additional aspects, the electrically ignitable fluid 200 may be non-self-igniting. For example, in response to an electrical pulse being applied to the electrically ignitable fluid 200, the electrically ignitable fluid 200 may generate a small, contained explosion proximate to the electrical pulse that does not cause additional explosions in the electrically ignitable fluid 200. A non-limiting example of electrically ignitable fluid 200 includes a fluid having electrically ignitable propellant created by Digital Solid State Propulsion, Inc. In some aspects, the electrically ignitable fluid may include additional additives, such as proppant or diverters, for use of the electrically ignitable fluid as stimulation fluid in the wellbore 108.

The fracture 112 also includes mechanically excitable elements 202 within the electrically ignitable fluid 200. In some aspects, the mechanically excitable elements 202 may include any granular, piezoelectric material. The piezoelectric material may cause the mechanically excitable elements 202 to generate an electrical pulse in response to a mechanical stress, such as a compression force, exerted on the mechanically excitable elements 202. In some aspects, the mechanically excitable elements may include synthetic materials having piezoelectric characteristics. In other aspects, the mechanically excitable elements 202 may include natural piezoelectric elements, such as particles of the mineral magnesium borate (Mn₃B₇O₁₃), also known as boracite, or other natural piezoelectric materials, including, but not limited to tourmaline. In further aspects, the mechanically excitable elements 202 may include other materials, such as Rochelle salt (potassium sodium tartrate), barium titanate (BaTiO₃), or lead zirconate titanate (PZT), which may include ceramics that may be manufactured with doping materials (e.g., nickel, bismuth, niobium, lanthanum, or other ions), to form piezo characteristics. The mechanically excitable elements 202 may be dispersed in the electrically ignitable fluid 200 within the fracture 112 of the subterranean formation 110. In some aspects, as the electrically ignitable fluid 200 begins to exit the fracture 112 into the wellbore 108 of FIG. 1 or into a matrix of the subterranean formation 110, the fracture 112 may begin to close. The closing of the fracture 112 may cause the subterranean formation 110 to create a compression force on the mechanically excitable elements 202 positioned in the fracture 112. The compression force may cause the mechanically excitable elements 202 to generate a small electrical pulse, causing an explosion of the electrically ignitable fluid 200 proximate to the mechanically excitable elements 202.

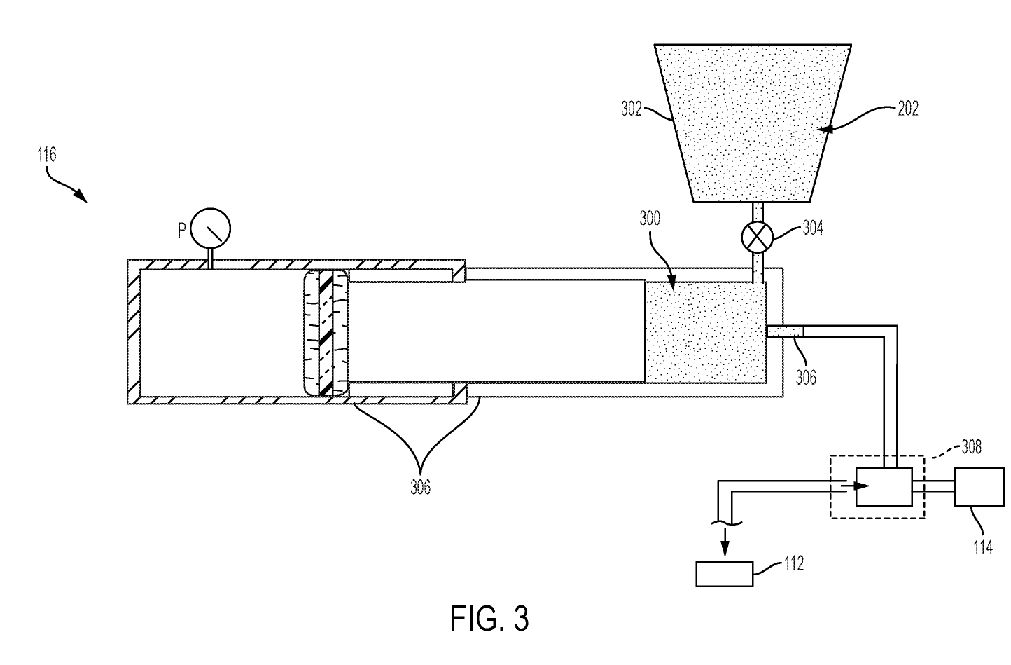

FIG. 3 is a cross-sectional view of the slow-injection pumping device 116 of FIG. 1 according to one aspect of the present disclosure. The slow-injection pumping device 116 includes a main chamber 300. The main chamber 300 may be fluidly connected to the pump 114 of FIG. 1 to allow the electrically ignitable fluid 200 to be pumped into the main chamber 300 of the slow-injection pumping device 116 for injection into the fracture 112 of FIG. 2. The slow-injection pumping device 116 may also include a supply tank 302. The supply tank 302 may be separated from the main chamber 300 by an inlet valve 304. Non-limiting examples of the inlet valve 304 may include a ball valve or a flood valve. In some aspects, the inlet valve 304 may be configured to fully open to allow the mechanically excitable elements 202 to enter the main chamber 300. In some aspects, the inlet valve 304 may be configured to open and close at a rate that does not cause the inlet valve 304 to close onto the mechanically excitable elements 202, thereby compressing or otherwise exerting a compression force onto the mechanically excitable elements 202. In some aspects, the inlet valve 304 may be automated to open and close and defined intervals of time. In other aspects, the inlet valve 304 may be controlled by an operator positioned at the surface 104.

The slow-injection pumping device 116 includes one or more plungers 306. The plungers 306 may represent intensifying plungers or pistons configured to create opposing pressures in the main chamber 300 to suck fluids into and extract fluids from the main chamber 300. In some aspects, the mechanically excitable elements 202 may initially be positioned in the supply tank 302. The plungers 306 may create a suction pressure in response to a back stroke of the plungers 306 to cause the mechanically excitable elements 202 to enter the main chamber 300 from the supply tank 302 through the inlet valve 304. The plungers 306 may subsequently perform a forward stroke to compress the fluids in the main chamber 300.

The slow-injection pumping device 116 also includes a nozzle 308. The electrically ignitable fluid 200 flowing into the main chamber 300 from the pump 114 of FIG. 1 and the mechanically excitable elements 202 may be mixed by the slow-injection pumping device 116. In some aspects, the slow-injection pumping device 116 may pump the mixed electrically ignitable fluid 200 and the mechanically excitable elements 202 through the tubing to be injected into the fracture 112. When the injection device 116 is positioned downhole near the fracture, as depicted by block 116B, the mechanically excitable elements 202 may be pumped through a coiled tubing (or small tubing) directly into the wellbore and into the injection device 116. The electrically ignitable fluid 200 may be pumped through the nozzle 308 and into an annulus where it is mixed with the mechanically excitable elements 202 prior to entering the fracture 112.

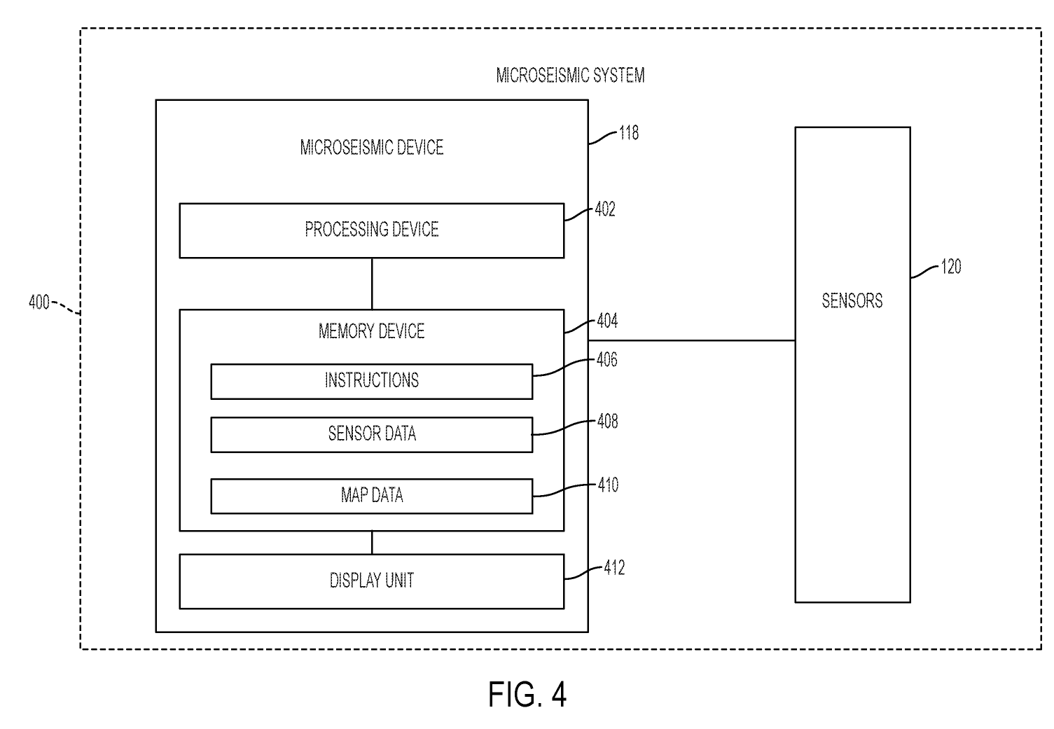

FIG. 4 is block diagram of a microseismic system 400 for generating a map of the fracture of FIG. 1 according to one aspect of the present disclosure.

The microseismic system 400 may include the microseismic device 118 and the array of sensors 120 of FIG. 1. The microseismic device 118 may be communicatively coupled to the sensors 120 via a wired or wireless connection. The microseismic device 118 includes a processing device 402 and a memory device 404. The processing device 402 may be communicatively coupled to the memory device 404 via a bus or other suitable connection. The processing device 402 may execute instructions 406 including one or more algorithms for determining locations of explosions of the electrically ignitable fluid 200 in the fracture 112 of FIG. 2, generating a map of the fracture 112 using the locations of the explosions, and determining characteristics of the fracture 112 using the fracture map. In some aspects, the instructions 406 may be stored in the memory device 404 to allow the processing device 402 to perform the operations. In some aspects, the processing device 402 may include a single processor. In other aspects, the processing device 402 may include multiple processing devices. Non-limiting examples of the processing device 402 may include a field-programmable gate array (“FPGA”), an application-specific integrated circuit (“ASIC”), a microprocessor, etc. The memory device 404 may include any type of storage device that retains stored information when powered off. Non-limiting examples of the memory device 404 may include electrically erasable and programmable read-only memory (“EEPROM”), a flash memory, or any other type of non-volatile memory. In some examples, at least a portion of the memory device 404 may include a computer-readable medium from which the processing device 402 can read the instructions 406. A computer-readable medium may include electronic, optical, magnetic, or other storage devices capable of providing the processing device 402 with computer-readable instructions or other program code. Non-limiting examples of a computer-readable medium include, but are not limited to, magnetic disks, memory chips, ROM, random-access memory (“RAM”), an ASIC, a configured processor, optical storage, or any other medium from which a compute processor can read the instructions 406. The instructions 406 may include processor-specific instructions generated by a compiler or an interpreter from code written in any suitable computer-programming language, including, for example, C, C+++, C#, etc.

The memory device 404 may also include sensor data 408 corresponding to the measurements received from the array of sensors 120 positioned in the wellbore 108 of FIG. 1. The processing device 402 may receive signal from the sensors 120 corresponding to the measurements of the sensors, extract data from the signals, and store the data as sensor data 408 in the memory device 404. In some aspects, the microseismic device 118 may determine an input for the instructions 406 based on the sensor data 408. For example, the instructions 406 may include algorithms for determining the position of explosions of the electrically ignitable fluid 200 in the fracture using the sensor data 408. In one example, the instructions 406 may include an algorithm corresponding to a triangulation routine or other known equivalent calculation to determine the location of an explosion in the fracture 112 in relation to the position of the sensors 120. In some aspects, the sensor data 408 may also include data corresponding to the position of the sensors 120 in the wellbore 108, in addition to the measurements from the sensors 120 that may be used to determine the location of the explosion. In one example, the microseismic device 118 may determine a depth of the fracture in the wellbore 108 based on known depths of the sensors 120 in the wellbore 108. In some aspects, the microseismic device 118 may store the determined locations of the explosions as map data 410 to generate a fracture map including each location of an explosion in the fracture 112. The instructions 406 may include additional algorithms to determine characteristics of the fracture 112 using the map data 410 or the fracture map generated from the map data 410. In one example, the instructions 406 may include known measurement equations to determine a distance between two or more explosion locations stored as map data 410 to determine a size, width, or length of the fracture 112. In another example, the instructions 406 may include code for generating graphical interfaces, such as data plots, that, when executed by the processing device 402, may cause the microseismic device 118 to display the determined locations of each of the detected explosions in the fracture 112 on a two-dimensional or three-dimensional axis. In some aspects, the data plots of the explosion locations may be displayed on a display unit 412 of the microseismic device 118 to illustrate a geometry or orientation of the fracture 112 in the subterranean formation 110. The display unit 412 may include any CRT, LCD, OLED, or other device for displaying interfaces generated by the processing device 402. In additional and alternative aspects, the instructions 406 may include known imaging algorithms to determine such characteristics of the fracture based on the positional relationship of the explosion locations with respect to one another.

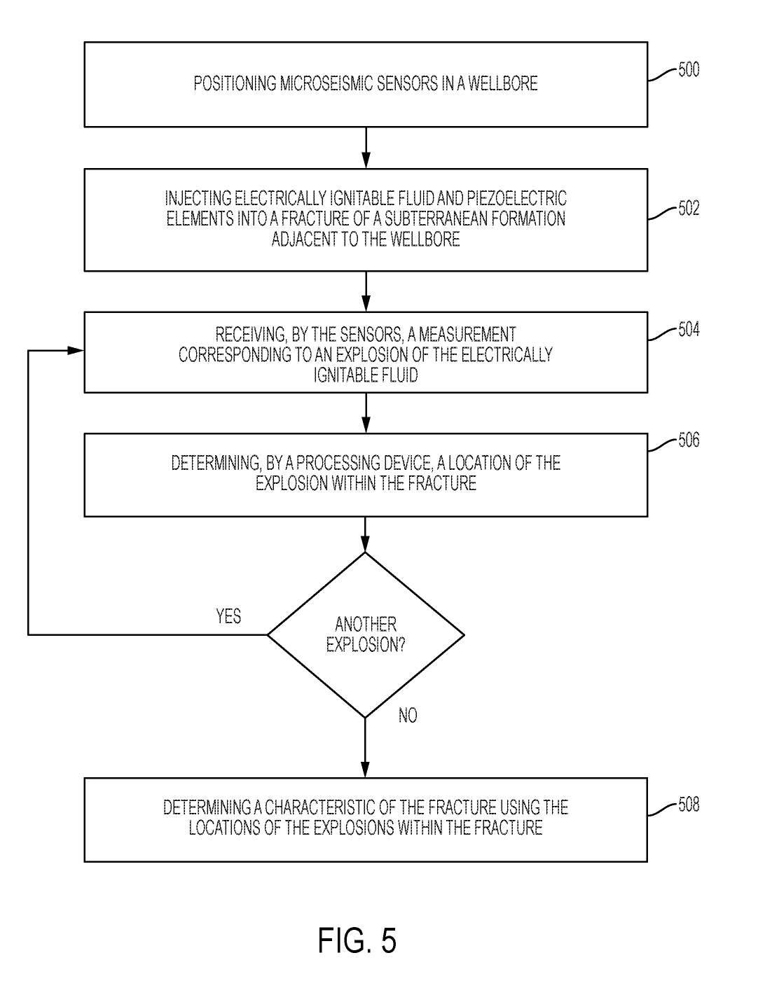

FIG. 5 is a flow chart describing a process for determining a characteristic of the fracture of FIG. 1 according to one aspect of the present disclosure. The process is described with reference to the wellbore environment with reference to the wellbore environment 100 of FIG. 1, unless otherwise indicated, though other implementations are possible without departing from the scope of the present disclosure.

In block 500, the sensors 120 of the microseismic system may be positioned to monitor acoustic sound in the wellbore 108. The sensors 120 may be positioned in the wellbore 108 using any suitable means. In some aspects, the sensors 120 may be positioned in the wellbore 108. For example, the sensors 120 may be positioned on the tubing string 106 in the wellbore as described in FIG. 1. In another example, the sensors 120 may be coupled to a casing of the wellbore 108. In other aspects, the sensors may be positioned at the surface 104 or in a nearby wellbore. The sensors 120 may be positioned to measure acoustic sounds within the fracture 112 caused by explosions of the electrically ignitable fluid 200 of FIG. 2. In some aspects, the sensors 120 may be tuned to a frequency configured to detect the explosions. The sensors 120 may include multiple sensors positioned at various positions within the wellbore 108. In some aspects, one or more of the sensors 120 may be positioned proximate to the fracture 112 and other sensors 120 may be positioned at varying distances away from the fracture 112.

In block 502, the electrically ignitable fluid 200 and the mechanically excitable elements 202 of FIG. 2 are injected into the fracture 112. The slow-injection pumping device 116 may be configured to inject the electrically ignitable fluid 200 and the mechanically excitable elements 202 into the fracture 112. In some aspects, the electrically ignitable fluid 200 may be injected into the fracture 112 separately from the mechanically excitable elements 202. For example, the electrically ignitable fluid 200 may be pumped into the wellbore 108 and injected into the fracture 112 by the slow-injection pumping device 116. Subsequently, the mechanically excitable elements 202 may be injected into the fracture 112 and dispersed throughout the electrically ignitable fluid 200 positioned in the fracture 112. In alternative aspects, the electrically ignitable fluid 200 and the mechanically excitable elements 202 may be injected into the fracture 112 simultaneously. For example, the electrically ignitable fluid 200 may flow from the main chamber 300 of the slow-injection pumping device 116 of FIG. 3. The mechanically excitable elements 202 may be injected into the electrically ignitable fluid 200 in the main chamber 300 via the inlet valve 304 of the slow-injection pumping device 116 and the combination of the electrically ignitable fluid 200 and the mechanically excitable elements 202 may be injected into the fracture 112 through the nozzle 308.

In some aspects, the mechanically excitable elements 202 may be contained in the supply tank 302 of the slow-injection pumping device 116 of FIG. 3 for injection into the electrically ignitable fluid 200. The mechanically excitable elements 202 may be included in a concentrated liquid, such as a paste or a gel, that is slowly released into the flow of the electrically ignitable fluid 200 from the wellbore into the fracture 112. In one example, the electrically ignitable fluid 200 may be injected into the fracture 112 at a rate of ten barrels per minute. The mechanically excitable elements 202 may be injected into the electrically ignitable fluid 200 at a slower rate, e.g., 1 gallon per minute. The mechanically excitable elements 202 may be diluted from the concentrated liquid and dispersed in the electrically ignitable fluid 200 as it flows into the fracture 112.

In block 504, the sensors 120 may receive measurements corresponding to explosions of the electrically ignitable fluid 200 in the fracture 112. Each sensor 120 may be positioned in the wellbore 108, on the surface 104, or in a nearby well to sense each explosion in the fracture. In some aspects, the explosions of the electrically ignitable fluid 200 may be in response to electrical pulses created by the mechanically excitable elements 202 dispersed in the electrically ignitable fluid 200 in the fracture 112. For example, subsequent to a fracturing operation, the fracture 112 may begin to collapse, or otherwise, close. As the fracture closes, the subterranean formation may exert a compression force on to the mechanically excitable elements 202. The piezoelectric material of the mechanically excitable elements 202 may cause the mechanically excitable elements 202 to generate the electrical pulse. The explosion of the electrically ignitable fluid 200 in response to the electrical pulse may be contained in the area proximate to the mechanically excitable element 202 creating the electrical pulse. The electrically ignitable fluid 200 may be non-self-igniting to prevent the explosion of the electrically ignitable fluid 200 in one portion of the fracture 112 from causing additional explosions in other portions of the fracture 112.

The explosion of the electrically ignitable fluid 200 may generate one or more acoustic waves, or “pings” that may be measured by the sensors 120. In some aspects, the measurements may include the velocity of the acoustic waves and the frequency of the acoustic waves generated by the explosions. In some aspects, the time a ping is recorded by each of the sensors 120 may be used to triangulate the position of the source of the ping. In additional aspects, the sensors 120 may record the direction of the acoustic waves and whether they are compressional or shear waves. The sensors 120 may be tuned to a specific frequency for distinguishing the acoustic waves generated by the explosion of the electrically ignitable fluid 200 from other seismic sounds in the wellbore 108 (e.g., pings generated by the shifting of rocks in the subterranean formation 110 during the closing of the fracture 112). The measurements of the sensors 120 may be transmitted to the microseismic device 118 and stored in the memory device 404 of the microseismic device 118 as described in FIG. 4.

In block 506, the processing device 402 of the microseismic device 118 may determine a location of the explosion of the electrically ignitable fluid 200 within the fracture 112. In some aspects, the processing device 402 may determine the location of the explosion by comparing the sensor data 408 corresponding to the measurement of the explosion for each of the sensors 120. In additional aspects, the processing device 402 may also use the position of the sensors 120 in the wellbore 108 to triangulate the location of the explosion in the fracture 112.

In some aspects, the sensors 120 may continue to the receive measurements of additional explosions, as described in block 504, and may transmit measurements to the processing device 402 for determining locations of the additional explosions, as described in block 506. In block 508, the processing device 402 determines a characteristic of the fracture 112. In some aspects, the processing device 402 may generate a fracture map including each the locations of each explosion measured by the sensors 120.

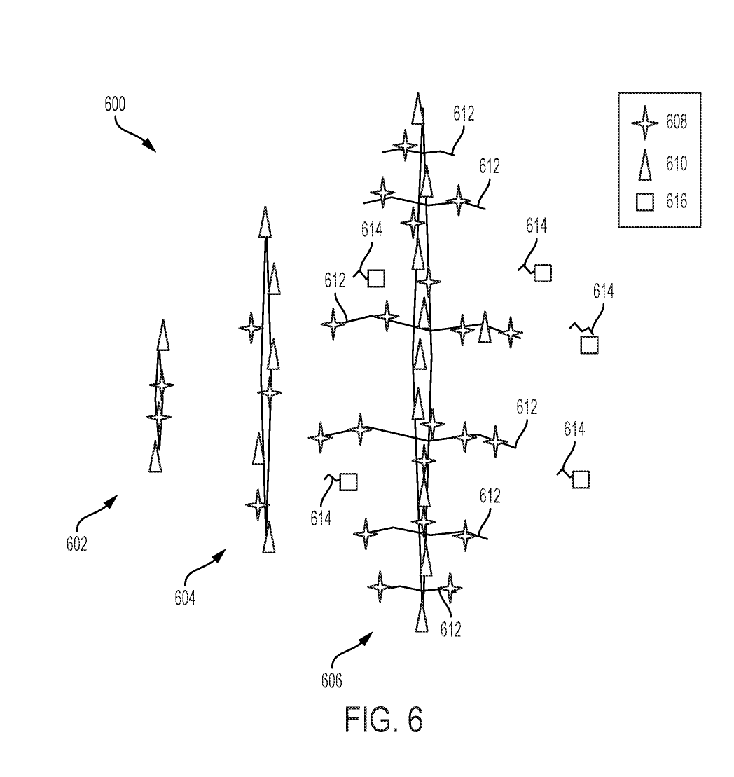

For example, FIG. 6 is a graphical illustration of an example of a progressive fracture map 600 including different-sized fracture maps that may be generated by the microseismic system 400 according to one aspect of the present disclosure. In particular, FIG. 6 shows the fracture 112 in stages as it develops from a small fracture 602 to a larger fracture 604 to a full fracture 606. The three fractures 602, 604, 606 shown are pictured as seen from the perspective of the wellbore 108, toward the tip of the fracture 112, thus having a vertical fracture opening. In the small fracture 602, as the fracture 602 opens, tensile crack pings 608 may be heard by the microseismic system 400 of FIG. 4. Should the fracture 602 close (e.g., the fracture stimulation stops), closure explosions 610 corresponding to the explosion of the electrically ignitable fluid 200 may be heard by the microseismic system 400.

As the fracture continues to extend to create the larger fracture 604, additional pings 608 may be heard by the microseismic system 400. Should the fracture 604 close, closure explosions 610 corresponding to the explosion of the electrically ignitable fluid 200 may be heard by the microseismic system 400. As the fracture extends to create the full fracture 606, additional pings 608 may be heard by the microseismic system 400. Because the full fracture 606 is significantly large, it may cross weak layer borders of the subterranean formation 110 that may slip to create connected horizontal fractures 612. As the horizontal fractures 612 are created by slipping, many pings 608 may be heard by the microseismic system 400. In some cases, the horizontal fractures 612 may open large enough to allow proppant and mechanically excitable elements 202 enter. Should the full fracture 606 close, closure explosions 610 corresponding to the explosion of the electrically ignitable fluid 200 may be heard by the microseismic system 400. The location data provided by the closure explosions 610 may provide accurate dimensions of the naturally producing fractures. The data may not report fractures that close back without support, e.g., non-producing fractures.

As fracture 606 opens, the fracture walls may push horizontally, creating a compressional force to the left and right of the fracture 606. The compressional force may cause unconnected horizontal fractures 614 to open in tensile. The unconnected horizontal fractures 616 may generate crack pings 616 that may be heard by the microseismic system 400. But, since these crack pings are not connected to the fracture 606, no mechanically excitable elements 202 and electrically ignitable fluid 200 may enter.

Pings generated by the conventional microseismic methods may define a much larger region as part of a stimulated reservoir volume (SRV) which may show larger success of the fracturing service. The closure explosions 610 corresponding to the explosions of the electrically ignitable fluid 200 may identify fractures that are connected to the wellbore 108 since only these fractures may allow the fluid 200 and the mechanically excitable elements 202 to enter. The pings from the explosives may identify only useful pings which reflect the connected stimulated reservoir volume and provide more useful dimensions to the wellbore operator.

In some aspects, methods and systems may be provided according to one or more of the following examples:

Example 1: A method may include positioning a plurality of sensors of a microseismic system to monitor acoustic sound in a wellbore. The method may also include injecting mechanically excitable elements and an electrically ignitable fluid in a fracture of a subterranean formation positioned adjacent to the wellbore. The method may also include receiving, by the plurality of sensors, measurements corresponding to a plurality of explosions of the electrically ignitable fluid within the fracture in response to electrical pulses created by the mechanically excitable elements within the electrically ignitable fluid. The method may also include determining, by a processing device of the microseismic system, a plurality of locations of the plurality of explosions within the fracture to create a map of the fracture.

Example 2: The method of Example 1 may feature injecting mechanically excitable elements and the electrically ignitable fluid in the fracture to include creating a mixture of the mechanically excitable elements and the electrically ignitable fluid by injecting the mechanically excitable elements into the electrically ignitable fluid. The method may also injecting mechanically excitable elements and the electrically ignitable fluid in the fracture to include creating a mixture of the mechanically excitable elements and the electrically ignitable fluid by injecting the mixture, subsequent to creating the mixture, into the fracture.

Example 3: The method of Example 2 may feature injecting mechanically excitable elements into the electrically ignitable fluid to include injecting a concentrated fluid including the mechanically excitable elements into the electrically ignitable fluid at a slower rate than a flow rate of the electrically ignitable fluid into the wellbore.

Example 4: The method of Example 1 may feature the mechanically excitable elements including at least one of boracite, tourmaline, potassium sodium tartrate, barium titrate, or lead zirconate titrate.

Example 5: The method of Example 1 may feature the mechanically excitable elements including piezoelectric material positionable in the fracture to generate the electrical pulses in response to a compression force exerted by the subterranean formation.

Example 6: The method of Example 1 may feature the plurality of sensors including three or more sensors. The method may also feature determining the plurality of locations of the plurality of explosions to include triangulating a position corresponding to each explosion of the plurality of explosions in the fracture.

Example 7: The method of Example 1 may feature a first explosion of the plurality of explosions being containable by the electrically ignitable fluid within a proximate area of the mechanically excitable elements without causing a self-ignited explosion of the electrically ignitable fluid in response to the first explosion.

Example 8: The method of Example 1 may also include determining a characteristic of the fracture using the plurality of locations of the plurality of explosions. The method may also feature the characteristic of the fracture including one of: a geometry of the fracture, a size of the fracture, an orientation of the fracture, a location of the fracture within the subterranean formation, or a depth of the fracture within the wellbore.

Example 9: A fracture-mapping system may include an injection device positionable downhole in a wellbore to inject an electrically ignitable fluid and mechanically excitable elements into a fracture of a subterranean formation positioned adjacent to the wellbore. The mechanically excitable elements may include piezoelectric material to generate electrical pulses in response to a compression force applied to the mechanically excitable elements. The electrically ignitable fluid ignitable in response to the electrical pulses to generate a plurality of explosions in the fracture. The system may also include a plurality of sensors positionable to detect measurements corresponding to the plurality of explosions of the electrically ignitable fluid within the fracture.

Example 10: The fracture-mapping system of Example 9 may feature a first explosion of the plurality of explosions being containable by the electrically ignitable fluid within a proximate area of the mechanically excitable elements without causing a self-ignited explosion of the electrically ignitable fluid in response to the first explosion.

Example 11: The fracture-mapping system of Example 9 may feature the injection device including an inlet valve actuatable to inject the mechanically excitable elements into the electrically ignitable fluid at a rate that is slower than a flow rate of the electrically ignitable fluid into the wellbore.

Example 12: The fracture-mapping system of Example 11 may feature the injection device further including a chamber positionable proximate to the inlet valve to contain a concentrated fluid including the mechanically excitable elements that is injectable into the electrically ignitable fluid.

Example 13: The fracture-mapping system of Example 12 may include the concentrated fluid being a paste or a gel including the mechanically excitable elements.

Example 14: The fracture-mapping system of Example 9 may feature the mechanically excitable elements including at least one of boracite, tourmaline, potassium sodium tartrate, barium titrate, or lead zirconate titrate.

Example 15: The fracture-mapping system of Example 9 may feature the mechanically excitable elements being positionable in the fracture to generate the electrical pulses in response to the compression force being applied to the mechanically excitable elements by the subterranean formation as the fracture closes.

Example 16: The fracture-mapping system of Example 9 may also include a microseismic device. The microseismic device may include a processing device couplable to the plurality of sensors to receive the measurements. The microseismic device may also include a memory device accessible by the processing device and including instructions executable by the processing device to a plurality of locations of the plurality of explosions. The plurality of locations may correspond to points on a surface of the fracture.

Example 17: A non-transitory computer-readable medium comprising program code executable by a processing device to cause the processing device to receive measurements from a plurality of sensors. The measurements may correspond to a plurality of explosions of electrically ignitable fluid within a fracture of a subterranean formation adjacent to the wellbore. The program code may also be executable by the processing device to cause the processing device to determine a plurality of locations of the plurality of explosions within the fracture, each location of the plurality of locations corresponding to a position of an electrical pulse generated by a mechanically excitable element within the electrically ignitable fluid. The program code may also be executable by the processing device to cause the processing device to determine a characteristic of the fracture using the plurality of locations of the plurality of explosions.

Example 18: The non-transitory computer-readable medium of Example 17 may feature the program code being executable by the processing device to cause the processing device to receive the measurements from at least three sensors of the plurality of sensors. The program code may also be executable by the processing device to cause the processing device to determine the plurality of locations of the plurality of explosions by triangulating a position for each explosion of the plurality of explosions.

Example 19: The non-transitory computer-readable medium of Example 17 may feature the program code being executable by the processing device for causing the processing device to determine the characteristic of the fracture by generating a fracture map that associates the plurality of locations with points on one or more surfaces of the fracture.

Example 20: The non-transitory computer-readable medium of Example 17 may feature the characteristic of the fracture including one of: a geometry of the fracture, a size of the fracture, an orientation of the fracture, a location of the fracture within the subterranean formation, or a depth of the fracture within the wellbore.

The foregoing description of the examples, including illustrated examples, has been presented only for the purpose of illustration and description and is not intended to be exhaustive or to limit the subject matter to the precise forms disclosed. Numerous modifications, adaptations, uses, and installations thereof can be apparent to those skilled in the art without departing from the scope of this disclosure. The illustrative examples described above are given to introduce the reader to the general subject matter discussed here and are not intended to limit the scope of the disclosed concepts.

What is claimed is:

1. A method, comprising:
positioning a plurality of sensors of a microseismic system to monitor acoustic sound in a wellbore;
injecting mechanically excitable elements and an electrically ignitable fluid in a fracture of a subterranean formation positioned adjacent to the wellbore;
receiving, by the plurality of sensors, measurements corresponding to a plurality of explosions of the electrically ignitable fluid within the fracture in response to electrical pulses created by the mechanically excitable elements within the electrically ignitable fluid; and
determining, by a processing device of the microseismic system, a plurality of locations of the plurality of explosions within the fracture to create a map of the fracture.

2. The method of claim 1, wherein the injecting mechanically excitable elements and the electrically ignitable fluid in the fracture includes:
creating a mixture of the mechanically excitable elements and the electrically ignitable fluid by injecting the mechanically excitable elements into the electrically ignitable fluid; and
injecting the mixture, subsequent to creating the mixture, into the fracture.

3. The method of claim 2, wherein injecting mechanically excitable elements into the electrically ignitable fluid includes injecting a concentrated fluid including the mechanically excitable elements into the electrically ignitable fluid at a slower rate than a flow rate of the electrically ignitable fluid into the wellbore.

4. The method of claim 1, wherein the mechanically excitable elements include at least one of boracite, tourmaline, potassium sodium tartrate, barium titrate, or lead zirconate titrate.

5. The method of claim 1, wherein the mechanically excitable elements include piezoelectric material positionable in the fracture to generate the electrical pulses in response to a compression force exerted by the subterranean formation.

6. The method of claim 1, wherein the plurality of sensors includes three or more sensors, wherein determining the plurality of locations of the plurality of explosions includes triangulating a position corresponding to each explosion of the plurality of explosions in the fracture.

7. The method of claim 1, wherein a first explosion of the plurality of explosions is containable by the electrically ignitable fluid within a proximate area of the mechanically excitable elements without causing a self-ignited explosion of the electrically ignitable fluid in response to the first explosion.

8. The method of claim 1, further including determining a characteristic of the fracture using the plurality of locations of the plurality of explosions, wherein the characteristic of the fracture includes one of: a geometry of the fracture, a size of the fracture, an orientation of the fracture, a location of the fracture within the subterranean formation, or a depth of the fracture within the wellbore.

9. A fracture-mapping system, comprising:
an injection device positionable downhole in a wellbore to inject an electrically ignitable fluid and mechanically excitable elements into a fracture of a subterranean formation positioned adjacent to the wellbore, the mechanically excitable elements including piezoelectric material to generate electrical pulses in response to a compression force applied to the mechanically excitable elements, the electrically ignitable fluid ignitable in response to the electrical pulses to generate a plurality of explosions in the fracture; and
a plurality of sensors positionable to detect measurements corresponding to the plurality of explosions of the electrically ignitable fluid within the fracture.

10. The fracture-mapping system of claim 9, wherein a first explosion of the plurality of explosions is containable by the electrically ignitable fluid within a proximate area of the mechanically excitable elements without causing a self-ignited explosion of the electrically ignitable fluid in response to the first explosion.

11. The fracture-mapping system of claim 9, wherein the injection device includes an inlet valve actuatable to inject the mechanically excitable elements into the electrically ignitable fluid at a rate that is slower than a flow rate of the electrically ignitable fluid into the wellbore.

12. The fracture-mapping system of claim 11, wherein the injection device further includes a chamber positionable proximate to the inlet valve to contain a concentrated fluid including the mechanically excitable elements that is injectable into the electrically ignitable fluid.

13. The fracture-mapping system of claim 12, wherein the concentrated fluid is a paste or a gel including the mechanically excitable elements.

14. The fracture-mapping system of claim 9, wherein the mechanically excitable elements include at least one of boracite, tourmaline, potassium sodium tartrate, barium titrate, or lead zirconate titrate.

15. The fracture-mapping system of claim 9, wherein the mechanically excitable elements are positionable in the fracture to generate the electrical pulses in response to the compression force being applied to the mechanically excitable elements by the subterranean formation as the fracture closes.

16. The fracture-mapping system of claim 9, further including a microseismic device including:
a processing device couplable to the plurality of sensors to receive the measurements; and
a memory device accessible by the processing device and including instructions executable by the processing device to a plurality of locations of the plurality of explosions, the plurality of locations corresponding to points on a surface of the fracture.

17. A non-transitory computer-readable medium comprising program code executable by a processing device to cause the processing device to:
receive measurements from a plurality of sensors, the measurements corresponding to a plurality of explosions of electrically ignitable fluid within a fracture of a subterranean formation adjacent to the wellbore;
determine a plurality of locations of the plurality of explosions within the fracture, each location of the plurality of locations corresponding to a position of an electrical pulse generated by a mechanically excitable element within the electrically ignitable fluid; and
determine a characteristic of the fracture using the plurality of locations of the plurality of explosions.

18. The non-transitory computer-readable medium of claim 17, wherein the program code is executable by the processing device to cause the processing device to:
receive the measurements from at least three sensors of the plurality of sensors; and
determine the plurality of locations of the plurality of explosions by triangulating a position for each explosion of the plurality of explosions.

19. The non-transitory computer-readable medium of claim 17, wherein the program code is executable by the processing device for causing the processing device to determine the characteristic of the fracture by generating a fracture map that associates the plurality of locations with points on one or more surfaces of the fracture.

20. The non-transitory computer-readable medium of claim 17, wherein the characteristic of the fracture includes one of: a geometry of the fracture, a size of the fracture, an orientation of the fracture, a location of the fracture within the subterranean formation, or a depth of the fracture within the wellbore.
